(19) United States
(12) Patent Application Publication
(10) Pub. No.: US 2009/0154835 A1
(43) Pub. Date: Jun. 18, 2009

(54) Method for Rotating An Image and Digital Cameras Using The Same

(76) Inventor: Chi-Jung Weng, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/038,121

(22) Filed: Feb. 27, 2008

(30) Foreign Application Priority Data
Dec. 14, 2007 (TW) 096148107

(51) Int. Cl. G06K 9/32; H04N 5/76

(52) U.S. Cl. 382/296; 348/231.99

(57) ABSTRACT

A method for rotating an image and digital cameras using the same are disclosed. The method comprises: determining whether to auto-rotate an original image according to a rotate initial instruction; if yes, calculating a slope angle of the original image to rotate a first specific angle, wherein the slope angle is substantially equal to the first specific angle; if not, rotating the original image with a second specific angle according to at least a rotating instruction; and forming a rotated image.

### BACKGROUND OF THE INVENTION

1. Field of the Invention

The present invention relates to a method for rotating an image and to digital cameras using the same.

2. Description of the Related Art

Generally, it is common that photos are taken with vertical trees, buildings, or a flat coastline or skyline shown therein. When the user is taking the photo, if he/she presses the button too hard or for some other reason the digital camera is not held still, then the image might be skewed. If this should happen, the user has to either take another photo or use dedicated image processing software to rotate the image, which is usually processed in a computer.

Presently digital cameras can only rotate an image with 90 degrees and cannot rotate a skewed image with an angle of less than 90 degrees. Moreover, the rotated image can only be stored in the temporary storage and displayed on the screen of the digital camera; in other words, the user can download only the original image to a computer or other devices, upon which the user must then rotate the image again. Using dedicated image processing software to rotate the skewed image is not only inconvenient but also time-consuming.

### SUMMARY OF THE INVENTION

In view of the deficiency of the prior art, the object of the present invention is to provide a method for rotating an image and digital cameras using the same. A digital camera disclosed in the present invention comprises a processor, a memory, an image capture module, and an edit interface. The image capture module is electrically coupled with the processor, wherein the image capture module is used for capturing an original image. The memory is electrically coupled with the processor, wherein the memory stores a program. The edit interface is used for receiving a plurality of instructions to command the processor to execute the program to achieve the mechanism described in the present invention; that is, to rotate the original image.

The mechanism, and also another feature of the present invention, is to provide a method for rotating an original image, the method comprising:

S1: determining whether to auto-rotate the original image according to a rotate initial instruction.

S2: If the determination of S1 is “yes”, calculating a slope angle of the original image to rotate with a first specific angle, wherein the slope angle is substantially equal to the first specific angle. Furthermore, the step of calculating a slope angle of the original image further comprises:

S21: obtaining a brightness contrast line of the original image (for example, the brightness contrast line is captured according to a brightness contrast value of the original image); and

S22: calculating an included angle between the brightness contrast line and a horizontal zero degree line or a vertical ninety degree line, wherein the included angle is substantially equal to the first specific angle (that is, the slope angle of the original image).

S3: If the determination of S1 is “no”, rotating the original image with a second specific angle according to at least a rotating instruction (for example, the edit interface receives the instruction inputted by the user), wherein the user can input the rotating instruction several times to rotate the original image with a multiple of second specific angles.

S4: forming a rotated image. Furthermore, the method disclosed in the present invention can further perform the following steps:

After the S2 step is done, the method proceeds to S41: determining whether to accept the rotated image; and

S431: If the determination of S41 is “yes”, storing the rotated image and deleting the original image; that is, overwriting the original image, or the method proceeds to

S432: If the determination of S1 is “yes”, storing both the rotated image and the original image; that is, saving the rotated image elsewhere and preserving the original image.

Alternatively, after the S3 step is done, the method proceeds to S42: determining whether to accept the rotated image. If the determination of S42 is “yes”, then the method also proceeds to S431 or S432.

If the determination is “no” in S41, then the method goes back to S1 for a subsequent determination. If the determination is “no” in S42, then the method goes back to S3 to rotate the original image with the second specific angle according to the rotating instruction.

### BRIEF DESCRIPTION OF THE DRAWINGS

FIG. 1 illustrates a system block view of a digital camera in accordance with the present invention;

FIG. 2 illustrates a structural view of the digital camera from the user side in accordance with an embodiment of the present invention;

FIGS. 3A and 3B illustrate the scene in the viewfinder and the original image taken from the scene in accordance with an embodiment of the present invention;

FIG. 4 illustrates a flow chart of the method for rotating the image in accordance with an embodiment of the present invention;

FIGS. 5A to 5D are diagrams of the edit interface of the digital camera in the process of rotating the original image in accordance with an embodiment of the present invention.

### REFERENCE NUMERALS

| | |
|---|---|
| 1□digital camera | 11□processor |
| 12□memory | 16□display device |
| 13□image capture module | 14□edit interface |
| 120□program | 140□input key |

### DETAILED DESCRIPTION OF THE PREFERRED EMBODIMENT

The advantages and innovative features of the invention will become more apparent from the following detailed description when taken in conjunction with the accompanying drawings.

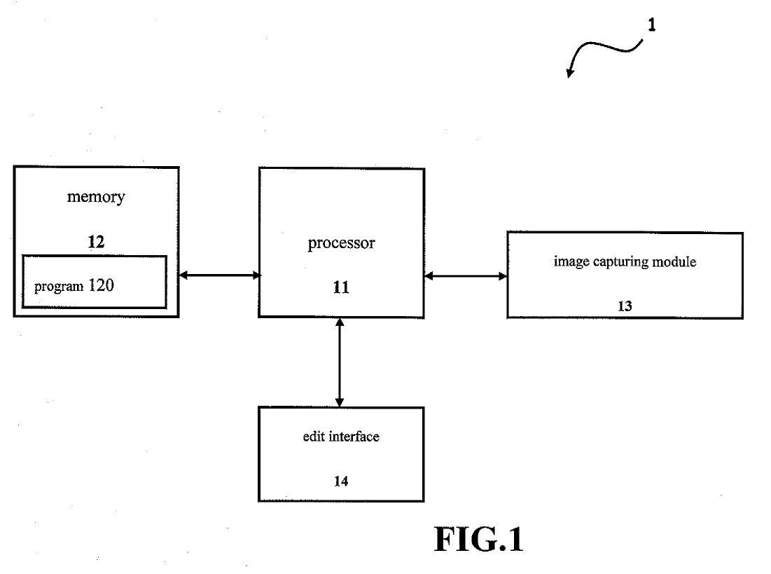

The present invention provides a method for rotating an image and digital cameras using the same. Please refer to FIG. 1; the present invention discloses a digital camera 1 comprising a processor 11, a memory 12, an image capture module 13 and an edit interface 14. The memory 12, image capture module 13 and edit interface 14 are electrically coupled with the processor 11 respectively. The image capture module (such as a CCD) 13 is used for capturing an original image. The memory 12 is used for storing the program 120. The edit interface 14 is used for receiving a plurality of instructions to command the processor 11 to execute the program 120 to achieve the mechanism described in the present invention; that is, to rotate the original image.

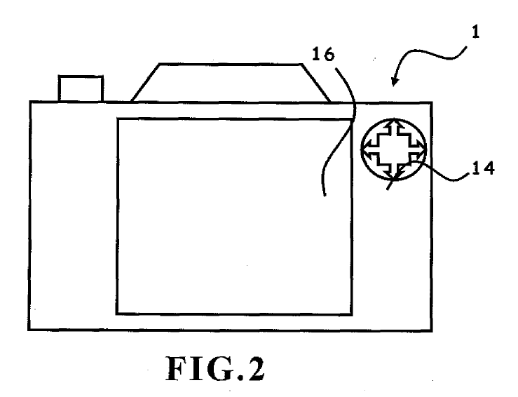

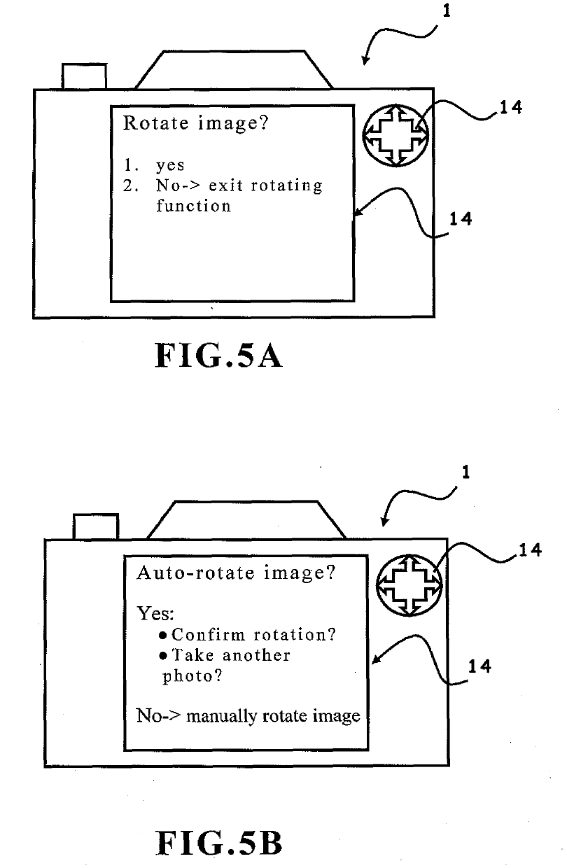

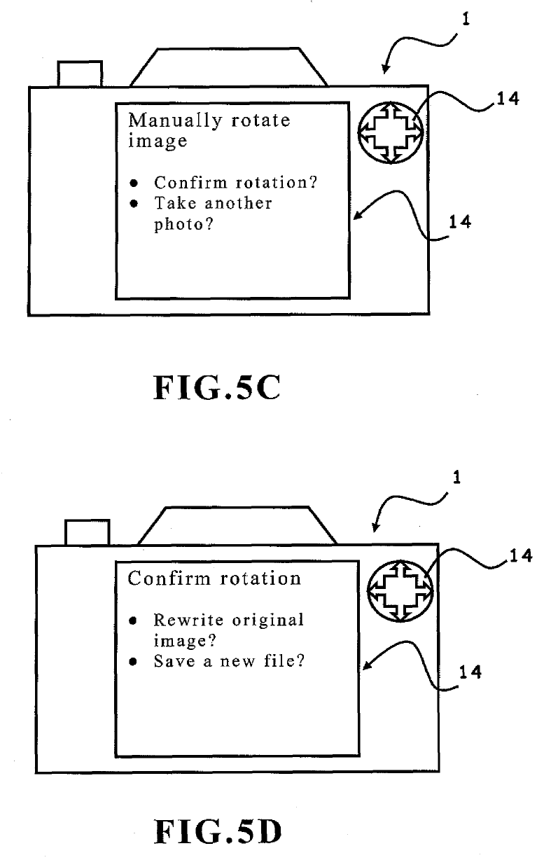

For example, please refer to FIG. 2. The present invention provides an input key 140 comprising up, down, left and right functions for a user to input an instruction; that is, the user uses the edit interface 14 (as shown in FIGS. 5A˜5D, which will be described in detail below) shown on the display device 16 and inputs a plurality of instructions by the input key 140 to control the operation (such as executing the program 120) of the processor 11.

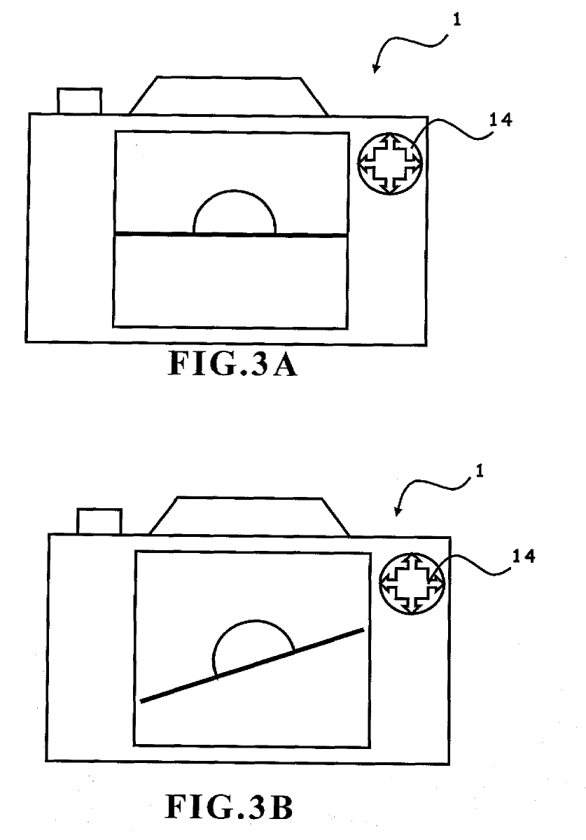

For example, please refer to FIG. 3A. When the user wants to shoot a sunset scene, if the user presses the shutter too hard and thus interferes with the operation of the image capture module 12 (as shown in FIG. 1), then the captured original image is skewed; then the digital camera 1 disclosed in the present invention can rotate the original image by using the processor 11 to execute the program 120.

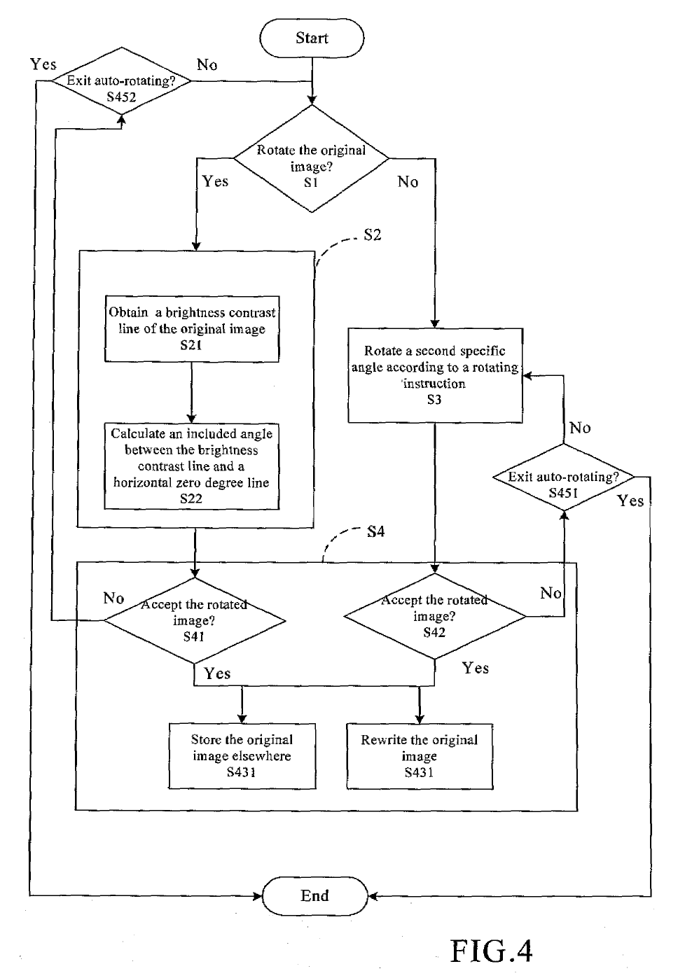

The mechanism, and also another feature of the present invention, is to provide a method for rotating an original image. Please refer to FIG. 4; when the user captures an original image and previews the original image (such as by using “Play Back” to browse through the images) and finds the original image is skewed (as shown in FIG. 3B), he/she can use the image rotating function disclosed in the method of the present invention. For example, the digital camera presents the edit interface 14 shown in FIG. 5A for the user to further choose the settings. As illustrated by FIG. 5A, when the user chooses “yes” in the edit interface 14 (that is, the edit interface 14 receives a rotate initial instruction), the present invention proceeds to S1; otherwise, the image rotating function is not executed.

Please refer back to FIG. 4; in the S1 step: determining whether to auto-rotate the original image according to a rotate initial instruction. If the determination of S1 is “yes”, please also refer to FIG. 5B; the user can choose the “yes” instruction in the edit interface 14 to commend the processor 11 to execute the program 120, which is auto-rotating the original image in this embodiment.

The method proceeds to S2: calculating a slope angle of the original image to rotate with a first specific angle, wherein the slope angle is substantially equal to the first specific angle. Furthermore, the step of calculating a slope angle of the original image further comprises S21: obtaining a brightness contrast line of the original image (for example, the brightness contrast line is captured according to a brightness contrast value of the original image); and S22: calculating an included angle between the brightness contrast line and a horizontal zero degree line or a vertical ninety degree line, wherein the included angle is substantially equal to the first specific angle (that is, the slope angle of the original image).

For example, a digital signal processor (not shown in the figures) can calculate the brightness contrast value according to the original image in FIG. 3B to obtain a brightness contrast line (such as a coastline). The processor 11 can calculate the included angle between the brightness contrast line and a horizontal zero degree line by executing the program 120 and then rotate the original image with the included angle (the first specific angle).

Please refer back to FIG. 4; if the determination is “no” in S1, for example, as shown in FIG. 5B, the user can choose the “no” instruction in the edit interface 14 to control the processor 11 to execute the program 120, which is manually rotating the original image in this embodiment. The method proceeds to S3: rotating the original image with a second specific angle according to at least a rotating instruction (for example, the edit interface 14 receives the instruction inputted by the user). To be more specific, in order to fine-tune the original image, the user can manually input the rotating instruction by pressing the input key 140 towards the left or the right to rotate the original image with one degree (or more than one degree or less than one degree) at a time; therefore, in this embodiment, the user can press the input key 140 several times to rotate the original image with a multiple of second specific angles (depending on what angle the user desires for the original image). Since the second specific angle can be controlled by a parameter, it will not be further described for the sake of brevity.

Finally, the method proceeds to S4: forming a rotated image. Furthermore, the method disclosed in the present invention can further perform the following steps S41 and S42: determining whether to accept the rotated image. For example, the auto-rotating step in FIG. 5B or the manually rotating step in FIG. 5C can further determine whether to accept the rotated image; afterwards, the method proceeds to overwrite the original image or to save the rotated image elsewhere (that is, to save it as a new file).

Therefore, please refer back to FIG. 4; after the auto-rotating step in S2 is done, if the determination is “yes” in 841, the method proceeds to S431: storing the rotated image and deleting the original image, or overwriting the original image (in S432): storing both the rotated image and the original image, or saving the rotated image elsewhere and preserving the original image.

Similarly, after the manual rotation step in S3 is done, if the determination is “yes” in S42, the method proceeds to S431: storing the rotated image and deleting the original image, that is to overwrite the original image, or the method proceeds to S432: storing both the rotated image and the original image, that is to save the rotated image elsewhere and to preserve the original image.

If the determination is “no” in S41, then the method proceeds to S452 to determine whether to exit the auto-rotating function. If the determination is “no” in S452, the method goes back to S1 for another determination; if the determination is “yes” in S452, then the method exits the auto-rotating mode. Similarly, if the determination is “no” in S42, then the method proceeds S451 to determine whether to exit the manual rotation mode; if the determination is “no” in S451, the method goes back to S3 to rotate the original image according to the rotating instruction; if the determination is “yes” in S451, then the method exits the manual rotation mode.

Although the present invention is illustrated by rotating an original image with respect to the horizontal direction, it is noted that the method is not limited to the horizontal direction, for as those skilled in the art should know, the original image can be vertical (such as buildings or trees), and the included angle can be calculated with respect to the vertical direction so as to rotate the original image with the included angle.

Many changes and modifications in the above described embodiment of the invention can, of course, be carried out without departing from the scope thereof. Accordingly, to promote progress in science and the useful arts, the invention is disclosed and is intended to be limited only by the scope of the appended claims.

What is claimed is:

1. A digital camera comprising:
a processor;
a memory electrically coupled with the processor, wherein the memory stores a program;
an image capture module electrically coupled with the processor, wherein the image capture module is used for capturing a original image; and
an edit interface for a user to input a plurality of instructions to command the processor to execute the program to achieve the mechanism described below, wherein the plurality of instructions comprises a rotate initial instruction and at least a rotating instruction:
when the user inputs the rotate initial instruction, the processor determines whether to auto-rotate the original image;
if yes, calculating a slope angle of the original image to rotate a first specific angle, wherein the slope angle is substantially equal to the first specific angle;
if not, rotating the original image with a second specific angle according to the rotating instruction inputted by the user; and
forming a rotated image.

2. The digital camera as claimed in claim 1, wherein the step of calculating a slope angle of the original image further comprises:
obtaining a brightness contrast line of the original image; and
calculating an included angle between the brightness contrast line and a horizontal zero degree line or a vertical ninety degree line, wherein the included angle is substantially equal to the slope angle.

3. The digital camera as claimed in claim 2, wherein the brightness contrast line is captured according to a brightness contrast value of the original image.

4. The digital camera as claimed in claim 1, wherein the processor executes the program to achieve the mechanism described below:
determining whether to accept the rotated image; and
if yes, storing the rotated image and deleting the original image.

5. The digital camera as claimed in claim 1, wherein the processor executes the program to further achieve the mechanism described below:
determining whether to accept the rotated image; and
if yes, storing both the rotated image and the original image.

6. A method for rotating an original image, wherein the original image is captured by a digital camera, the method comprising:
determining whether to auto-rotate the original image according to a rotate initial instruction;
if yes, calculating a slope angle of the original image to rotate a first specific angle, wherein the slope angle is substantially equal to the first specific angle;
if not, rotating the original image with a second specific angle according to the rotating instruction inputted by the user; and
forming a rotated image.

7. The method as claimed in claim 6, wherein the step of calculating a slope angle of the original image further comprises:
obtaining a brightness contrast line of the original image; and
calculating an included angle between the brightness contrast line and a horizontal zero degree line or a vertical ninety degree line, wherein the included angle is substantially equal to the slope angle.

8. The method as claimed in claim 7, wherein the brightness contrast line is captured according to a brightness contrast value of the original image.

9. The method as claimed in claim 6 further comprising:
determining whether to accept the rotated image; and
if yes, storing the rotated image and deleting the original image.

10. The digital camera as claimed in claim 6 further comprising:
determining whether to accept the rotated image; and
if yes, storing both the rotated image and the original image.
